(19) United States
(12) Patent Application Publication
(10) Pub. No.: US 2016/0224251 A1
(43) Pub. Date: Aug. 4, 2016

(54) SYSTEMS AND METHODS IN SUPPORT OF DYNAMIC DATA MANAGEMENT

(71) Applicant: LIN XU, Carlisle, MA (US)

(72) Inventor: LIN XU, Carlisle, MA (US)

(21) Appl. No.: 14/610,428

(22) Filed: Jan. 30, 2015

(51) Int. Cl. G06F 3/06; G06F 17/30

(52) U.S. Cl. CPC G06F 3/0607; G06F 3/0685; G06F 3/0619; G06F 3/0643; G06F 17/302; G06F 17/30238; G06F 3/067

(57) ABSTRACT

A system and method for dynamic data management may receive a request from an operating system (OS) of a computer for device parameters to be provided to the OS; provide virtual Mass Storage Device (MSD) parameters, wherein the virtual MSD parameters cause the OS to determine that the device has an OS-supported file system, and wherein the device does not have an OS-supported file system; receive from the OS, based on the virtual MSD parameters, data retrieval requests, wherein each data retrieval request comprises at least a request for information regarding files of data and corresponding data management information; map data stored in the data storage medium to the data retrieval requests; and provide a virtual data map to the OS based on the mapping; wherein the virtual data map enables the OS to retrieve and manage the information regarding the files of data.

### FIELD OF THE INVENTION

The present invention is in the field of data management. In particular, the present invention is directed to providing systems and methods in support of dynamic data management.

### BACKGROUND OF THE INVENTION

Most modern data logging systems, digital cameras included, employ their own built-in processors to process acquired sensor data, and store the data into system memory. Data can be stored into a removable storage device (for example, a Secure Digital (SD) flash memory card) in the case of most digital cameras, or internal memory in the case of some mobile telephones and other devices. For short-term and long-term data storage, data is typically transferred to computers. In order to make the data accessible by most operating systems, stored data needs to be presented in a commonly recognized format. In the case of a removable storage device, the data logging system needs to organize data to comply with one of the commonly recognized file systems. In the case of built-in storage, data is typically sent through a hardware interface (for example, a Universal Serial Bus (USB) port or a memory card reader, Ethernet, wireless storage drive etc.) to connect to a computer, and present data either through a dedicated program or be mounted as a storage device.

To manage data file objects and folder structures, conventional data logging systems in general use a file system manager to manage storage devices to comply with a commonly recognizable file systems (for example, the 32 bit File Allocation Table—“FAT32”—computer file system). However, simple data logging systems often have to face choices of either using dedicated computer drivers and programs to transfer data, or investing in complex and more expensive hardware and firmware resources to include an internal file system manager.

What is needed, therefore, is a solution that addresses this conflict for simple and small footprint platforms which are typically under restricted processing power and memory resources.

### SUMMARY OF EMBODIMENTS OF THE INVENTION

An embodiment of the invention includes a method and system in support of dynamic data management. Embodiments may be performed on or by a device for example having a processor, device memory, one or more code sets stored in the device memory and executed by the processor, and an interface for operatively connecting to a computer. In some embodiments, the processor is operatively connected to a data storage medium having data stored therein. In some embodiments, the method may include such steps as identifying the data stored in the data storage medium; receiving a request from an operating system (OS) of a computer operatively connected to the interface, for one or more device parameters to be provided to the OS; providing one or more virtual Mass Storage Device (MSD) parameters, in which the one or more virtual MSD parameters cause the OS to determine that the device has an OS-supported file system, when the device does not have an OS-supported file system. In some embodiments, the method may further include receiving from the OS, based on the one or more virtual MSD parameters, one or more data retrieval requests, in which each data retrieval request includes at least a request for information regarding one or more files of data and corresponding data management information; mapping data stored in the data storage medium to the one or more data retrieval requests; and providing a virtual data map to the OS based on the mapping, in which the virtual data map enables the OS to retrieve the information regarding the one or more files of data.

Some embodiments may include receiving, at the processor, a read request for the information regarding the one or more files of data to be retrieved; locating in the data storage medium, the mapped data via the virtual data map; and providing the information regarding the one or more files of data to the OS. In some embodiments, the device is a data logging device, and the data storage medium is integrated memory and/or memory of a sensor that has been operatively connected to the data logging device. In some embodiments, the device parameters comprise one or more of a category of device, a device name, a device manufacturer, a device type, a memory capacity, a description of a device file system, a number of clusters, a number of sectors per cluster, and a number of bytes per sector.

In some embodiments, the information regarding the one or more files of data includes at least one of a file list, a size of each respective file of the one or more files, file creation date and time, file update data and time, a pointer to a file system table, a location of a file directory, and one or more file directory entries. In some embodiments, the corresponding data management information includes at least one of one or more addresses in a file system table. In some embodiments, the data stored in the data storage medium is raw data, formatted data which is in a format that is incompatible with the OS, or formatted data which is in a format that is compatible with the OS. In some embodiments, the method may include translating the data stored in the data storage medium into a format that is compatible with the OS in real time when the data is requested by the OS.

In some embodiments, mapping the data stored in the data storage medium to the one or more data retrieval requests includes correlating or linking one or more actual locations of the data with one or more virtual location entries in the virtual data map, in which the one or more virtual location entries are associated with the one or more data retrieval requests in real time. In some embodiments, the method may include receiving, at the processor, a write request for one or more computer files of data to be written to one or more locations in a MSD; mapping the one or more locations of the write request to one or more actual locations in the data storage medium; and writing the one or more computer files of data to the one or more mapped locations in the data storage medium. In some embodiments, the method may include translating the one or more computer files of data into a format that is compatible with the data storage in real time when the data is provided by the OS.

These and other aspects, features and advantages will be understood with reference to the following description of certain embodiments of the invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high level diagram illustrating a small footprint data logging system according to at least one embodiment of the invention; and

FIG. 2 is a flow diagram of a method of providing dynamic data management according to at least one embodiment of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory processor-readable storage medium that may store instructions, which when executed by the processor, cause the processor to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof may occur or be performed simultaneously, at the same point in time, or concurrently.

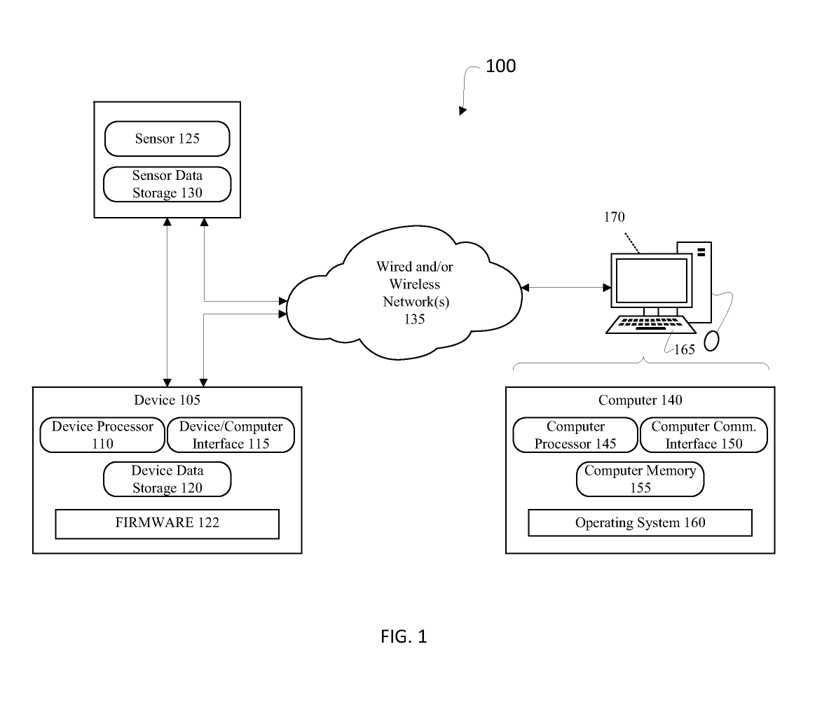

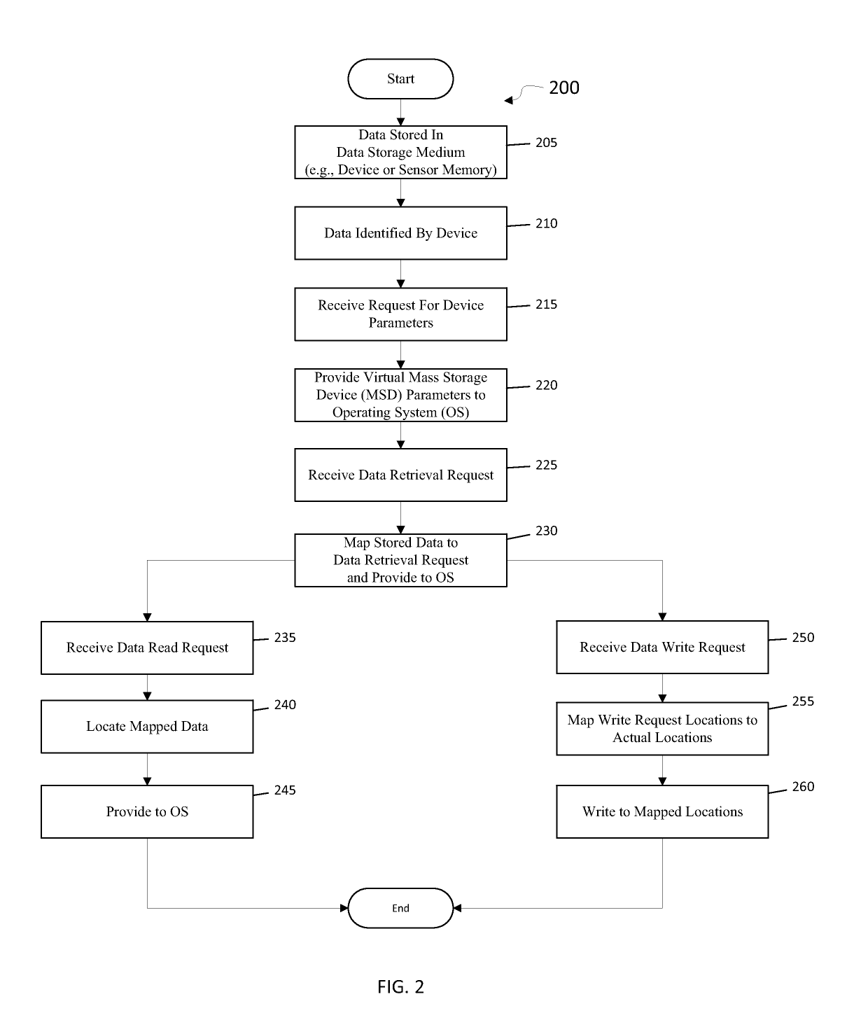

Embodiments of the invention enable dynamic data management by providing systems and methods which dynamically map (e.g., “on-the-fly”) stored and/or captured data with data requests made by a file management system of a connected computer, as described herein. Furthermore, embodiments of the invention enable writing to internal memory of a data logging device (or to external memory connected thereto), by employing the same dynamic mapping principles, as described herein. These and other features of embodiments of the invention will be further understood with reference to FIGS. 1-2 as described herein.

FIG. 1 is a high level diagram illustrating a small footprint data logging system 100 according to at least one embodiment of the invention. In some embodiments, system 100 includes a device 105, such as a data logging device, which is configured for logging data produced, e.g., by one or more sensors and/or other data generating devices. A data logging device (also called a datalogger or data recorder) may be an electronic device that records data over time or in relation to location, using, for example, a built in instrument or sensor or via external instruments and sensors. Typically, data logging devices are small, battery powered, portable, and equipped with a microprocessor, some internal memory for basic data storage, and one or more integrated and/or connected sensors. Some data loggers interface with a personal computer or other computing device and utilize software to activate the data logger and view and analyze the collected data, while others have a local interface device (keypad, LCD) and can be used as a stand-alone device.

Device 105 may include a simple and/or small footprint platform which is typically under restricted processing power, data management, and memory resources. The device 105 may include a device processor 110 (e.g., a microprocessor), which is operatively connected to various hardware and software components that serve to enable operation of the system 100. Device processor 110 serves to execute instructions to perform various operations relating to data management, and other functions of embodiments of the invention as will be described in greater detail below. Device processor 110 may be one or a number of processors, a micro-controller, a central processing unit (CPU), a graphics processing unit (GPU), a multi-processor core, or any other type of processor, depending on the particular implementation.

In some embodiments, the device 105 may include a computer interface 115 for interfacing with a computer and/or other devices. For example, computer interface 115 may include, but is not limited to, a Universal Serial Bus (USB) for physically connecting to a computer, a modem, a Network Interface Card (NIC), an integrated network interface, a radio frequency transmitter/receiver (e.g., Bluetooth wireless connection, cellular, Near-Field Communication (NFC) protocol, a satellite communication transmitter/receiver, an infrared port, a USB connection, and/or any other such interfaces for connecting device 105 to other computing devices and/or communication networks such as private networks and the Internet.

In some embodiments, device 105 may also include device data storage 120. Device data storage 120 may include, for example, one or more memory Integrated Circuits (ICs) which may be connected to the processor 110 to store data, temporarily (e.g., removable storage) or permanently (e.g., integrated in the device), for example, to protect data during power loss or system resets. In certain implementations, device data storage 120 is accessible by device processor 110, thereby enabling device processor 110 to receive and execute instructions such a code, stored in the memory and/or storage in the form of one or more software modules, each module representing one or more code sets, and collectively referred to as device firmware 122. The device firmware 122 may include one or more software programs or applications (collectively referred to as the “firmware”) having computer program code or a set of instructions executed partially or entirely in device processor 110 for carrying out operations for aspects of the systems and methods disclosed herein, and may be written in any combination of one or more programming languages. Device processor 110 may be configured to carry out embodiments of the present invention by, for example executing code or software, and may be or may execute the functionality of the firmware 122, which performs data collecting and manipulation and manages data storage, as described herein.

In some embodiments, one or more sensors 125, such as a Global Positioning System (GPS), an accelerometer, and/or a digital image/video capture device, for example, may be connected to the device processor 110 to collect data. In some embodiments, sensor 125 may include sensor data storage 130, which, like device data storage 120, may be removable or integrated, and which may be configured to store data captured by the sensor 125. Of course, in other embodiments, data captured by sensor 125 may be stored directly to device data storage 120, for example, when sensor 125 does not have any removable or integrated storage.

In some embodiments, device 105 may be connected, e.g., via computer interface 115 and/or over a wired and/or wireless network, such as network 135, to a computer, such as, computer 140. In some embodiments, network 135 may include one or more wired and/or wireless connections, the Internet, one or more telephony networks, one or more network segments including local area networks (LAN) and wide area networks (WAN), one or more wireless networks, or a combination thereof. Communication with computer 140 may be, for example, direct or indirect through further machines that are accessible to the network 135.

Computer 140 may be any suitable computing device and/or data processing apparatus capable of communicating with device 105, other remote devices or computing networks, receiving, transmitting and storing electronic information and processing requests as further described herein. Computer 140 is therefore intended to represent various forms of digital computers, such as laptops, tablets, desktops, workstations, personal digital assistants, mobile devices, servers, blade servers, mainframes, and other appropriate computing devices and/or networked or cloud based computing systems.

Computer 140 may be any standard computing device. As understood herein, in accordance with one or more embodiments, a computing device may be a stationary computing device, such as a desktop computer, kiosk and/or other machine, each of which generally has one or more processors, such as computer processor 145, configured to execute code to implement a variety of functions (e.g., methods as disclosed herein), a computer-readable memory, such as computer memory 155, a computer communication interface 150, for connecting to the network 135, and/or device 105, one or more computer modules representing an operating system (OS), such as OS 160, one or more input devices, such as input devices 165, and one or more output devices, such as output devices 170. Typical input devices, such as, for example, input devices 165, may include a keyboard, pointing device (e.g., mouse or digitized stylus), a web-camera, and/or a touch-sensitive display, etc. Typical output devices, such as, for example output device 170 may include one or more of a monitor, display, speaker, printer, etc.

In some embodiments, OS 160 may be executed by computer processor 145 to provide the various functionalities of computer device 140. In particular, in some embodiments, computer module 160 may provide a user interface with which a user of computer 140 may interact, to, among other things, manage data on device 105, as described herein. Computer memory 155 may be, for example, a random access memory (RAM) or any other suitable volatile or non-volatile computer readable storage medium. Computer memory 155 may also include storage which may take various forms, depending on the particular implementation. For example, the storage may contain one or more components or devices such as a hard drive, a flash memory, a rewritable optical disk, a rewritable magnetic tape, or some combination of the above. In addition, the memory and/or storage may be fixed or removable. In addition, memory and/or storage may be local to the computer 140 or located remotely.

Additionally or alternatively, computer 140 may be a mobile electronic device (“MED”), which is generally understood in the art as having hardware components as in the stationary device described above, and being capable of embodying the systems and/or methods described herein, but which may include componentry such as wireless communications circuitry, gyroscopes, inertia detection circuits, geolocation circuitry, touch sensitivity, among other sensors. Non-limiting examples of typical MEDs are smartphones, personal digital assistants, tablet computers, and the like, which may communicate over cellular and/or Wi-Fi networks or using a Bluetooth or other communication protocol. Typical input devices associated with conventional MEDs include, keyboards, microphones, accelerometers, touch screens, light meters, digital cameras, and the input jacks that enable attachment of further devices, etc.

In some embodiments, as described in further detail herein with respect to FIG. 2, when the interface 115 is connected to computer 140 (e.g., via computer communication interface 150), the firmware 122 may negotiate with the computer 140, and when the interface 115 is a USB, the firmware 122 may provide device parameters which may present the device 105 as a standard USB Mass Storage Device Class. The USB mass storage device class (also known as USB MSC or UMS) is a set of computing communications protocols which may make a USB device accessible to a host computing device and enable file transfers between the host and the USB device. Typically, based on Mass Storage Device (MSD) parameters provided to the OS (e.g., a specified command set and/or any subset), the USB mass storage device class may provide a means to read and write sectors of data to/from an OS-supported file system (e.g., a file system with which an OS is configured to read and/or write data, and/or with which the OS is generally compatible and/or compliant) to the device. Operating systems may treat a USB mass-storage device like a hard drive; users may partition it in any format (such as MBR and GPT), and format it with any file system.

Because of its relative simplicity, a common file system on devices such as, e.g., USB flash drives, cameras, or digital audio players, etc., is the File Allocation Table (“FAT”, e.g., FAT32) file system, described in detail herein. Large, USB-based hard disks may be formatted with proprietary file systems, such as, e.g, the New Technology File System “NTFS”. However, a thumb drive or other device may be formatted with another file system (e.g., HFS Plus on an Apple Macintosh, Ext2 on Linux, and/or Unix File System on Solaris or BSD) so as to contain an OS-supported file system. This choice may limit (or prevent) access to a device's contents by equipment using a different OS.

In some embodiments, though the firmware 122 may provide device parameters (e.g., “virtual” MSD parameters, as described in detail herein), which may present the device 105 as a standard USB Mass Storage Device Class with an OS-supported file system, the device may actually have no OS-supported file system, as would be expected of devices presented as such. In some embodiments, the device may not even be an MSD and/or may not have the componentry and/or software typically associated with an MSD. After OS 160 has mounted the device 105 as an Mass Storage Device (“MSD”), the firmware 122 may interact with the OS 160, provide drive parameters, and transfer either data acquired from the sensor 125, or data previously stored in the device memory (e.g., device data storage 120).

FIG. 2 is a flow diagram of a method of providing dynamic data management according to at least one embodiment of the invention. In some embodiments, method 200 may be performed on a device (e.g., device 105), such as a data logging device, having a device processor (e.g., device processor 110), device memory (e.g., device data storage 120), and one or more code sets (e.g., firmware 122) stored in the device memory and executing in the device processor. The method begins at step 205, when data is stored in a data storage medium such as, for example, device memory and/or data storage of an operatively connected device (e.g., sensor data storage 130 of sensor 125). While a sensor is discussed herein, data in embodiments of the present invention may be associated with devices other than sensors. A sensor, as understood herein, is a device that detects and/or responds to some type of input from the physical environment. The specific input may be light, heat, motion, moisture, pressure, or any one of a number of other environmental phenomena. The output is generally a signal (e.g., data) that is, for example, converted and presented to a human-readable display, stored locally (e.g., in sensor data storage) for later use, or transmitted electronically over a communication interface and/or a network for storage, reading and/or further processing. Non-limiting examples of sensors include GPS devices, digital image capture devices (e.g., video cameras and digital cameras), digital thermometers, photosensors, etc. The output signal may include, for example, an image, GPS coordinates, a temperature reading, etc.

In some embodiments, the device may be configured to activate one or more integrated and/or connected sensors to capture sensor data (e.g., periodically, randomly, based on a predefined event, etc.). In some embodiments, such as when a sensor is configured to store data in its own internal memory, the device may be configured to control management of the data in the sensor's internal memory. In some embodiments, when a sensor captures data, the data may be logged (e.g., recorded, stored, tracked, etc.) by a data logging device and the data may be stored in the data storage medium. In some embodiments, the data storage medium may be integrated memory (of the device) and/or memory of a sensor that has been operatively connected to the data logging device.

Data (e.g., sensor data) may be stored in any number of different formats. For example, the data may be stored as raw data, as formatted data which is in a format that is incompatible with a computer OS (e.g., that is incompatible with any OS-supported file systems, but which may be operable for viewing on a device display, for example), and/or formatted data which is in a format that is compatible with a computer OS (e.g., (e.g., that is compatible with one or more OS-supported file systems, for example in a directly readable format). In some embodiments, the device may arrange (e.g., store) the data in a way that is convenient to the system, e.g., in fragmented sectors of memory, in blocks, etc.

At step 210, in some embodiments, the device processor may identify the data stored in the data storage medium. For example, the device may not have its own power source, or the power source may have been disconnected. In such embodiments, once power is restored (e.g., when the device is plugged into (e.g. connected to) a power-providing USB drive of a computer or to another external power source, or when an internal power source is activated or replenished), the device may be configured to scan internal or operatively connected memory to identify the data stored in a given data storage medium, including, for example, identifying where in the data storage medium the data is stored, and/or the total amount of data stored. Of course, in some embodiments data may not be identified until, for example, a request for data to be read from or written to the device is made by a connected computer.

At step 215, once the device has been operative connected to an OS of a computer via a an interface of the device (e.g., directly or indirectly via a network, as described herein), which may facilitate communication between the device and the OS, the device processor may receive a request from the OS of a computer, for one or more device parameters to be provided to the OS. While an OS is discussed herein, in embodiments of the present invention, requests and other communications between the device and the computer may be initiated and/or implemented by one or more applications and/or programs installed on the computer and interacting with the OS. Device parameters may include, for example, one or more of a category of device, a device name, a device manufacturer, a device type, a memory capacity, a description of a device file system, a number of clusters, a number of sectors per cluster, and/or a number of bytes per sector. Typically, when a device is connected to a computer, the OS of the computer is configured to begin determining what the device is, and how the computer may communicate with the device. Different devices have different purposes and functionalities, and the OS may request one or more device parameters to determine what those purposes and functionalities are. For example, when an input device (e.g., a mouse or keyboard) is plugged in or otherwise connected to a computer, the OS must identify what type of input device has been connected, at which point it may load one or more drivers related to the identified input device.

A driver, as understood herein, is software that allows a computer to communicate with hardware or devices. Without drivers, hardware connected to a computer, for example, a video card or a web-enabled camera, may not function properly. A driver may act like a translator between the device and programs that may want to communicate with and use the device, such as the OS. Each device typically has its own set of specialized commands for implementing its functionality. In contrast, most programs access devices by using generic commands. The driver, therefore, accepts generic commands from a program and then translates them into specialized commands for the device. Operating systems typically have a variety of drivers preinstalled which allow for at least basic communication with, and control of, standard peripheral devices such a mouse, keyboard, and, significantly, a mass storage device, such as an external hard drive or a USB flash drive.

An MSD is a storage device typically used to host data on a removable media (e.g., a hard disk drive, a magnetic tape drive, a magneto-optical disc drive, an optical disc drive, a solid-state drive, a tape library, a RAID system, flash drive, etc.). Mass storage does not include random access memory (RAM), which is volatile in that it loses its contents after power loss. Data is typically organized in an MSD by use of a file system which is used to control how data is stored and retrieved. Without a file system, all information placed in a storage area would be stored in one large body of data, with no way to tell where one piece of information stops and the next begins. By separating the data into individual pieces (e.g., sectors, clusters, etc.), and giving each piece a name, the information is easily separated and identified. The set of structure and logic rules used to manage the groups of information and their names is called a “file system”.

A common file system implemented on many MSD is the FAT computer system architecture. It is, however, supported for compatibility reasons by nearly all currently developed operating systems for personal computers and many mobile devices and embedded systems, and thus is a well-suited format for data exchange between computers and devices of almost any type and age from the last 35 years up to the present. FAT file systems are commonly found on MSDs, and many other portable and embedded devices. There have been many iterations of the FAT file system. One of the formats currently in use is the FAT32 file system, in which cluster values are represented by 32-bit numbers, e.g., presented in a FAT table, of which 28 bits are used to hold the cluster number. However, the present invention is not limited to the FAT32 format, or the FAT format itself. The boot sector uses a 32-bit field for the sector count, limiting the FAT32 volume size to 2 Terabytes (TB) for a sector size of 512 bytes and 16 TB for a sector size of 4,096 bytes. Of course, many other file systems exist, many of which are also compatible with present day operating systems.

As described in detail herein, MSDs provide mass storage capabilities and include robust file management systems enabled to organize and manage large amounts of data. Since, in some embodiments, the device has relatively small storage capacity and no robust file management system, were the device to provide its own actual device parameters, the OS would not recognize it as a MSD. As such, at step 220, the device processor may provide one or more virtual Mass Storage Device (MSD) parameters to the OS in response to the received request for device parameters. The one or more virtual MSD parameters may be a set of one or more predefined or preprogrammed representations of device parameters typically associated with MSDs, including, for example, one or more device parameters related to an OS-supported file system resident in the MSD. However, as the device, in some embodiments, does not have an OS-supported file system, the parameters may be defined as virtual, and providing them to the OS may cause the OS to determine that the device does in fact have an OS-supported file system with which it may communicate, when in fact it does not. Similarly, in some embodiments, the device may not in fact be an MSD, and therefore providing the virtual parameters to the OS may cause the OS to determine that the device is a MSD. In some embodiments, these virtual MSD parameters may be either included in the device firmware or stored in the system memory, e.g., to be provided upon request. When the OS receives the virtual MSD parameters, it will identify the device as a MSD and load its MSD driver for communicating with the device.

Once the OS determines that the connected device is a MSD (e.g., with a OS-supported file system), at step 225, the device processor may receive from the OS, based on the one or more virtual MSD parameters that have been previously provided, one or more data retrieval requests. A data retrieval request typically enables an OS to identify where data is stored in an MSD, and, possibly, what is contained in the data. For example, in some embodiments, a data retrieval request may include at least a request for information regarding one or more files of data and corresponding data management information. In some embodiments, the information regarding the one or more files may include, for example, a FAT table, a file and/or directory name list, a size of each respective file of the one or more files, file creation date and time, file update data and time, a pointer to a file system table, a location of a file directory, and one or more file directory entries. The corresponding data management information may include, for example, one or more addresses in a file system table, pointers to data, etc.

In some embodiments, the OS may first ask (e.g., in the data retrieval request) for a specific sector of data called a boot sector. A boot sector or boot block is a region of a data storage device that contains machine code and/or other information to be loaded into random-access memory (RAM) by a computer system's OS. The purpose of a boot sector is to provide a starting point for the OS to identify information on the storage device. The boot sector therefore may contain the location and/or size of file list sectors, and/or information relating to other storage management sectors, such as the location and/or size of FAT sectors. The first sector of a MSD file system is typically assigned as the boot sector, and this sector may be requested by the OS, as the OS has identified the device as a MSD with e.g., an OS-supported file system. However, as described herein, in accordance with embodiments of the invention, the device connected to the OS may not have an OS-supported file system and/or may not be an MSD, and therefore may not have a dedicated boot sector.

At step 230, in some embodiments, the device processor may map data stored in the data storage medium to the one or more data retrieval requests, and provide a virtual data map to the OS based on the mapping. In some embodiments, this may be a dynamic process, meaning that the process takes place at or after the moment it is required, rather than in advance. If the device were a standard MSD (e.g., an MSD with an OS-supported file system), it would simply provide the requested data locations, etc. However, because the device may not be a standard MDS (e.g., an MSD without an OS-supported file system, or a device other than an MSD), and, in some embodiments, does not have an OS-supported file system and/or file system management layer (e.g., dedicated software for internal file management), the firmware may manage data by configuring the processor to map the actual locations of data (e.g., one or more actual blocks or sectors of data representing disk structure or portion of files) in the data storage medium to requests by the OS on the fly (e.g., dynamically, rather than as the result of something that is statically predefined), and to record the mapping in a virtual data map. In some embodiments, mapping may mean identifying, connecting, linking, recording, tracking or otherwise noting a correlation, relationship, correspondence, or connection between data stored in the data storage medium and the one or more data retrieval requests. In some embodiments, the virtual data map is therefore a representation of this mapping, and reflects the correlations identified in the mapping. The virtual data map may be, for example, in the form of table with table entries reflecting the relationships, links, or any other suitable mechanism which identifies relationships or links between two or more items.

The virtual data map may then be provided to the OS as though it were standard data retrieval information being provided by, e.g., an MSD with an OS-supported file system. In some embodiments, such as when the device presents itself as a MSD with a FAT32 file system, the virtual data map may reflect information organized in a FAT32 system, despite being calculated on the run and provided to the OS as sectors and/or clusters of data. As the OS makes data retrieval requests, e.g., for a particular sector of data (e.g., sectors which do not actually physically exist on the device, but which are perceived by the device to exist based on the provided virtual MSD parameters), the device may map data (e.g., data stored in actual physical locations within the device) to the data retrieval requests. As such, whenever the OS makes a call (e.g., a read request or write request) for that particular sector of data, the device may provide the originally mapped data stored in the device, as described herein.

In some embodiments, mapping the data stored in the data storage medium to the one or more data retrieval requests may include correlating or connecting one or more actual locations of the data with one or more virtual location entries in the virtual data map, as described herein. As described herein, in some embodiments the one or more virtual location entries may be associated with the one or more data retrieval requests in real time. As such, the device may not require a file system management layer, as the virtual data map may enable the OS to retrieve the information regarding the one or more files of data. Of course, the device also may not require a specialized device driver, as the OS may communicate with the device as though it were a standard MSD using a standard preprogrammed MSD driver. At this point, the OS is prepared to read data from the device, write data to the device, and generally communicate with the device as though it were a standard MSD, using the virtual information provided to it.

At step 235, the device processor may receive a data read request (hereinafter “read request”) for the information regarding the one or more files of data (e.g., a request for one or more blocks or sectors of data representing disk structure or portion of files) to be retrieved. By way of example, the device may contain four image files (e.g., digital photos) stored in the data storage medium in a manner convenient to the device (e.g., as raw data). A user of the computer may initiate a request, e.g., via the OS, to access the first image file. The OS will then call for specific sectors of data which, as far as it is concerned, contain the data reflecting the first image file. As such, at step 240, using the virtual data map, the device processor may locate the mapped data in the data storage medium via the virtual data map, e.g., by referencing the relevant identified correlation or connection which has been previously represented in the virtual data map. In doing so, the processor may find the corresponding actual locations where the requested data is being stored. At step 245, the processor may provide the information regarding the one or more files of data to the OS.

Similarly, at step 250, the processor may receive a data write request (hereinafter, “write request”) for one or more computer files of data to be written to one or more locations in a MSD (e.g., in what it has identified as an MSD based on the provided virtual MSD parameters). By way of example, the user may desire to transfer an audio file to the data storage medium. As such the user may transmit a write request, via the OS, to the device. While the OS may then provide specific sectors in which the data reflecting the audio file should be stored, such sectors do not actually exist. Instead, at step 255, the device processor may map the one or more locations of the write request to one or more actual locations in the data storage medium, and, at step 260, the device processor may write the one or more computer files of data (e.g., the audio file in the provided example) to the one or more mapped locations in the data storage medium. In some embodiments, when the write request includes a request by the OS to add a file, the OS may provide a file list sector containing, e.g., a new file name, and/or new FAT sectors with an updated FAT table including, e.g., newly added data sectors.

In some embodiments, write requests may be used by the device processor to control or otherwise manipulate one or more functions of an integrated or actively connected sensor. For example, when the sensor functionality is defined by a set-up file, a write request for a sensor set-up file to be written to the data storage medium may enable one or more functions of the sensor to be controlled. A setup file may contain one or more set-up commands such as, for example, to place a GPS sensor in “sleep mode” when the sensor does not detect movement for 30 seconds, or to record a temperature reading every five minutes, etc. In some embodiments, writing over a previously save set-up file and/or saving a new set-up file may result in reconfiguration of sensor parameters. Of course, in some embodiments, integrated and/or connected sensors may further connect and/or receive sensor parameters directly from the computer. In embodiments in which the device is connected via USB, an extra USB hub integrated circuit may provide extra channel for communication between the sensor and the computer.

Of course, in some embodiments, the device may be designated as “read-only”, which may prevent possible complications, such as when there is no enough available memory on the device and yet the OS is attempting to write a file to it with the incorrect assumption that there is space available. Of course, when file removal is detected, the firmware may arrange the file list and storage management table accordingly (e.g., remap the data as required), and then clear related data from internal data storage when necessary. In some embodiments, the OS may request that one or more files be removed or deleted, which may result in part or all of the data storage medium being erased or re-arranged.

In some embodiments, the processor may receive a write request for one or more computer files of data to be deleted from a MSD, e.g., when the OS receives a command for a file to be deleted from the data storage medium, and may provide a data write request to the device. The request may contain, for example, an instruction to modify the file name (of the file to be deleted) to indicate that the file may be written over in future requests. In such embodiments, information is not actually deleted or written into the sector/block at the time of the request. For example, in the case of FAT32, the OS may request that the device processor place (e.g., insert or otherwise append) an indicator (e.g., an 8-bit decimal number 229 or hex number E5) in position of the first character of the file name. As such, in some embodiments, the device processor may map one or more locations of the write request to one or more actual locations in the data storage medium, and may modify a file name associated with the one or more mapped locations in the data storage medium e.g., to indicate the one or more mapped locations may be rewritten. For example, the file name associated with the data file may be modified by placing the indicator, which may indicate that the corresponding file is no longer valid, and the memory occupied may be reused in a future write request. In some embodiments, when file deletion is requested, the OS may only provide the new file list sector and new FAT sectors. Of course, drive formatting may be implemented in a similar fashion.

It should be noted that, in some embodiments, such as when files have been saved to the data storage medium as raw data (e.g., data that has not been subjected to formatting, processing, and/or any other manipulation) the device processor may be configured to translate the data stored in the data storage medium into a format that is compatible with the OS and/or into a user-defined format in real time when the data is requested by the OS. Similarly, in some embodiments, formatted data stored in the data storage medium in one format may be translated by the device processor into another format, e.g., a user-defined format other than the current format, in real time when the data is requested by the OS. Conversely, the device processor may be configured to translate the one or more computer files of data provided by the OS into raw data, into a format that is compatible with the data storage medium, and/or into a user-defined format in real time. This may be particularly practical, for example, when a file has been compressed using a lossless file format. In this example, to save space, the file may be translated to a file format with a negligibly lossy file format. Of course, translation in either direction may not be required, for example, when data is stored in directly readable format (e.g., in a directly readable format). In such a case, there may be a 1:1 mapping with no translation required.

In some embodiments, the device may be configured to function in a data acquisition and/or data storage mode, e.g., when the device is not operatively connected to an OS. In data acquisition mode, the device may be configured to activate one or more sensors, as described herein, to capture (e.g., acquire) data. In data storage mode, the device may be configured to store and/or manage data that has been captured by the sensor or otherwise provided to the device, and store the data, e.g., in device data storage and/or sensor data storage. Of course, these modes may be concurrent (e.g., the device processor may control both data acquisition and data storage, simultaneously or nearly simultaneously, for example). In some embodiments, e.g., when the device is connected to the computer, the device may be configured to interact with the computer in an interaction mode to implement one or more of the steps described herein. In some embodiments, the device may be configured to operate in data acquisition and/or data storage mode when the device is detached or otherwise operatively disconnected from the OS and/or the computer. In some embodiments, the device may be configured to perform one or more functions of the various modes while operatively connected to the OS.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method in support of dynamic data management, performed on a device having a processor, device memory, one or more code sets stored in the device memory and executed by the processor, and an interface for operatively connecting to a computer, the processor being operatively connected to a data storage medium having data stored therein, the method comprising:
identifying, by the processor, the data stored in the data storage medium;
receiving, at the processor, a request from an operating system (OS) of a computer operatively connected to the interface, for one or more device parameters to be provided to the OS;
providing, by the processor, one or more virtual Mass Storage Device (MSD) parameters, wherein the one or more virtual MSD parameters cause the OS to determine that the device has an OS-supported file system, and wherein the device does not have an OS-supported file system;
receiving from the OS, at the processor, based on the one or more virtual MSD parameters, one or more data retrieval requests, wherein each data retrieval request comprises at least a request for information regarding one or more files of data and corresponding data management information;
mapping, by the processor, data stored in the data storage medium to the one or more data retrieval requests; and
providing, by the processor, a virtual data map to the OS based on the mapping;
wherein the virtual data map enables the OS to retrieve the information regarding the one or more files of data.

2. The method as in claim 1, further comprising:
receiving, at the processor, a read request for the information regarding the one or more files of data to be retrieved;
locating, by the processor, in the data storage medium, the mapped data via the virtual data map; and
providing the information regarding the one or more files of data to the OS.

3. The method as in claim 1, wherein the device is a data logging device, and wherein the data storage medium is at least one of integrated memory and memory of a sensor that has been operatively connected to the data logging device.

4. The method as in claim 1, wherein the device parameters comprise one or more of a category of device, a device name, a device manufacturer, a device type, a memory capacity, a description of a device file system, a number of clusters, a number of sectors per cluster, and a number of bytes per sector.

5. The method as in claim 1, wherein the information regarding the one or more files of data comprises at least one of a file list, a size of each respective file of the one or more files, file creation date and time, file update data and time, a pointer to a file system table, a location of a file directory, and one or more file directory entries.

6. The method as in claim 1, wherein the corresponding data management information comprises at least one of one or more addresses in a file system table.

7. The method as in claim 1, wherein the data stored in the data storage medium is one of raw data, formatted data which is in a format that is incompatible with the OS, and formatted data which is in a format that is compatible with the OS.

8. The method as in claim 7, further comprising translating the data stored in the data storage medium into one or more of a format that is compatible with the OS and a user-defined format in real time when the data is requested by the OS.

9. The method as in claim 1, wherein mapping the data stored in the data storage medium to the one or more data retrieval requests comprises:
correlating one or more actual locations of the data with one or more virtual location entries in the virtual data map, wherein the one or more virtual location entries are associated with the one or more data retrieval requests in real time.

10. The method as in claim 1, further comprising:
receiving, at the processor, a write request for one or more computer files of data to be written to one or more locations in a MSD;
mapping, by the processor, the one or more locations of the write request to one or more actual locations in the data storage medium; and
writing, by the processor, the one or more computer files of data to the one or more mapped locations in the data storage medium.

11. The method as in claim 10, further comprising:
translating the one or more computer files of data into one or more of a format that is compatible with the data storage and a user-defined format in real time when the data is provided by the OS.

12. The method as in claim 1, further comprising:
receiving, at the processor, a write request for one or more computer files of data to be deleted from a MSD;
mapping, by the processor, the one or more locations of the write request to one or more actual locations in the data storage medium; and
modifying, by the processor, a file name associated with the one or more mapped locations in the data storage medium to indicate the one or more mapped locations may be rewritten.

13. A system in support of dynamic data management performed on a device, the system comprising:
a processor, wherein the processor is operatively connected to a data storage medium having data stored therein;
an interface for operatively connecting to a computer;
device memory; and
one or more code sets stored in the device memory and executable by the processor, which, when executed, configure the processor to:
identify the data stored in the data storage medium;
receive a request from an operating system (OS) of a computer operatively connected to the interface, for one or more device parameters to be provided to the OS;
provide one or more virtual Mass Storage Device (MSD) parameters, wherein the one or more virtual MSD parameters cause the OS to determine that the device has an OS-supported file system, and wherein the device does not have an OS-supported file system;
receive, based on the one or more virtual MSD parameters, one or more data retrieval requests, wherein each data retrieval request comprises at least a request for information regarding one or more files of data and corresponding data management information;
map data stored in the data storage medium to the one or more data retrieval requests; and
provide a virtual data map to the OS based on the mapping;
wherein the virtual data map enables the OS to retrieve the information regarding the one or more files of data.

14. The system as in claim 13, wherein the code sets, when executed, cause the processor to:
receive a read request for the information regarding the one or more files of data to be retrieved;
locate in the data storage medium, the mapped data via the virtual data map; and
provide the information regarding the one or more files of data to the OS.

15. The system as in claim 13, wherein the device is a data logging device, and wherein the data storage medium is at least one of integrated memory and memory of a sensor that has been operatively connected to the data logging device.

16. The system as in claim 13, wherein the device parameters comprise one or more of a category of device, a device name, a device manufacturer, a device type, a memory capacity, a description of a device file system, a number of clusters, a number of sectors per cluster, and a number of bytes per sector.

17. The system as in claim 13, wherein the information regarding the one or more files of data comprises at least one of a file list, a size of each respective file of the one or more files, file creation date and time, file update data and time, a pointer to a file system table, a location of a file directory, and one or more file directory entries.

18. The system as in claim 13, wherein the corresponding data management information comprises at least one of one or more addresses in a file system table.

19. The system as in claim 13, wherein the data stored in the data storage medium is one of raw data, formatted data which is in a format that is incompatible with the OS, and formatted data which is in a format that is compatible with the OS.

20. The system as in claim 19, wherein the code sets, when executed, cause the processor to:
translate the data stored in the data storage medium into one or more of a format that is compatible with the OS and a user-defined format in real time when the data is requested by the OS.

21. The system as in claim 13, wherein the code sets, when executed, cause the processor to:
correlate one or more actual locations of the data with one or more virtual location entries in the virtual data map, wherein the one or more virtual location entries are associated with the one or more data retrieval requests in real time.

22. The system as in claim 13, wherein the code sets, when executed, cause the processor to:
receive a write request for one or more computer files of data to be written to one or more locations in a MSD;
map the one or more locations of the write request to one or more actual locations in the data storage medium; and
write the one or more computer files of data to the one or more mapped locations in the data storage medium.

23. The system as in claim 22, wherein the code sets, when executed, cause the processor to:
translate the one or more computer files of data into one or more of a format that is compatible with the data storage and a user-defined format in real time when the data is provided by the OS.

24. The system as in claim 13, wherein the code sets, when executed, cause the processor to:
receive a write request for one or more computer files of data to be deleted from a MSD;
map the one or more locations of the write request to one or more actual locations in the data storage medium; and
modify a file name associated with the one or more mapped locations in the data storage medium to indicate the one or more mapped locations may be rewritten.

25. A method in support of dynamic data management, performed on a device having a processor, device memory, and an interface for operatively connecting to a computer, the processor being operatively connected to a data storage medium having data stored therein, the method comprising:
receiving, at the processor, a request from a computer operatively connected to the interface, for one or more device parameters to be provided to the computer;
providing, by the processor, one or more virtual Mass Storage Device (MSD) parameters, wherein the one or more virtual MSD parameters present the device to the computer as a MSD;
receiving from the computer, at the processor, based on the one or more virtual MSD parameters, one or more data retrieval requests comprising requests for information regarding one or more files of data and corresponding data management information;
providing, by the processor, a virtual data map to the computer, the virtual data map indicating links between data stored in the data storage medium and the one or more data retrieval requests;
wherein the virtual data map enables the computer to retrieve the information regarding the one or more files of data.
